(19) United States
(12) Patent Application Publication
(10) Pub. No.: US 2010/0143800 A1
(43) Pub. Date: Jun. 10, 2010

(54) NEGATIVE ACTIVE MATERIAL FOR LITHIUM SECONDARY BATTERY, PREPARING METHOD THEREOF AND LITHIUM SECONDARY BATTERY INCLUDING THE SAME

(75) Inventors: Katsuya SAWADA, Osaka-shi (JP); Takeshi Deguchi, Osaka-shi (JP); Naoya Kobayashi, Osaka (JP); Toru Inagaki, Osaka (JP); Sung-Soo Kim, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignees: Samsung SDI Co., Ltd., Suwon-si (KR); TAYCA CORPORATION, Osaka (JP)

(21) Appl. No.: 12/606,926

(22) Filed: Oct. 27, 2009

(30) Foreign Application Priority Data
Oct. 28, 2008 (JP) 2008-276334
Oct. 22, 2009 (KR) 10-2009-0100775

(51) Int. Cl. H01M 4/131; H01M 4/88; H01M 4/133

(52) U.S. Cl. 429/220; 252/182.1; 429/231.4

(57) ABSTRACT

The present invention relates to a negative active material for a lithium secondary battery, a method of preparing the same, and a lithium secondary battery including the same. The negative active material for a lithium secondary battery includes a compound and a carbon composite represented by the following Chemical Formula 1.

LiₐV_{b}M_{c}O_{2+d} [Chemical Formula 1]

In the above Chemical Formula 1, a, b, c, and d represent a composition ratio, 0.1≦a≦2.5, 0.5≦b≦1.5, 0≦c≦0.5, 0≦d≦0.5, and M is Mg, Si, Sc, Cu, Zu, Nb, Y, or a combination thereof.

### CROSS-REFERENCE TO RELATED APPLICATION

This application claims priority to and the benefit of Japanese Patent Application No. 2008-276334 filed in the Japanese Intellectual Property Office on Oct. 28, 2008 and Korean Patent Application No. 10-2009-0100775 filed in the Korean intellectual Property Office on Oct. 22, 2009, the entire contents of which are incorporated herein by reference.

### BACKGROUND OF THE INVENTION

(a) Field of the Invention

This disclosure relates to a negative active material for a lithium secondary battery, a method of preparing the same, and a lithium secondary battery including the same.

(b) Description of the Related Art

Recently, as portable small electronic devices have been more widely used, active research on a lithium secondary battery with higher energy density as a power source thereof than other batteries has been undertaken. The lithium secondary battery in general includes a carbon material as a negative active material, in which Li ions (Li⁺) are injected between carbon (graphite) layers during charge and discharge. In other words, electrons move toward the carbon material of a negative electrode during the charge, and thus negatively charge the carbon, while Li ions intercalated at a positive electrode are deintercalated and intercalated into the negatively charged carbon material. On the contrary, Li ions intercalated into the carbon material of a negative electrode are deintercalated and intercalated into a positive o electrode during the discharge. Recently, a negative active material of a Li—V composite oxide, a Li—Ti composite oxide, or a composite oxide of lithium and transition elements instead of the carbon material has been suggested in order to overcome the small discharge capacity of a lithium secondary battery (Japanese Patent Laid-Open Publication No. Pyeung 6-60867). However, these negative active materials, for example, a Li—V composite oxide, is prepared through firing under an inert atmosphere such as argon and the like or under a reduction atmosphere such as nitrogen/hydrogen, argon/hydrogen, and the like. The firing under a reduction atmosphere may not be safe, and is also not good for mass production of a negative active material (Japanese Patent Laid-Open Publication No. 2006-128115, 2003-68305, 2005-216855, and 2002-216753). In addition, when the firing needs to be performed at 1000° C. or higher, particles may abnormally grow and have a wide particle size distribution, rarely preparing a negative active material with good characteristics.

### SUMMARY OF THE INVENTION

An exemplary embodiment of the present invention provides a negative active material for a lithium secondary battery with good battery characteristics.

Another embodiment of the present invention provides a method of preparing the negative active material for a lithium secondary battery.

Yet another embodiment of the present invention provides a lithium secondary battery including the negative active material.

According to an embodiment of the present invention, provided is a negative active material for a lithium secondary battery including a compound and a carbon composite with a composition represented by the following Chemical Formula 1.

LiₐV_{b}M_{c}O_{2+d} [Chemical Formula 1]

In the above Chemical Formula 1, a, b, c, and d represent a composition ratio, 0.1≦a≦2.5, 0.5≦b≦1.5, 0≦c≦0.5, 0≦d≦0.5, and M is Mg, Si, Sc, Cu, Zu, Nb, Y, or a combination thereof.

The carbon may be included in an amount of about 0.01 to 4.0 wt % based on the entire weight of the negative active material. In addition, the carbon may be included in an amount of about 1.0 to 3.0 wt % based on the entire weight of the negative active material.

Furthermore, the compound represented by Chemical Formula 1 may have a powder particle diameter ranging from about 5 to 50 μm.

The negative active material for a lithium secondary battery may have a lattice constant ratio (c/a) between a and c axes ranging from about 5.1 to 5.2.

According to another embodiment of the present invention, provided is a method of preparing a negative active material for a lithium secondary battery by firing a mixture of a lithium source material, a vanadium source material, and a carbon material, or a mixture of a lithium source material, a vanadium source material, a metal (M)-containing material, and a carbon material, and also including a compound and a carbon composite having a composition represented by Chemical Formula 1.

The lithium source material may be at least one selected from the group consisting of Li₂O, LiCl, LION lithium carbonate (Li₂CO₃), and lithium acetate (CH₃COOLi). The vanadium source material may be at least one selected from the group consisting of vanadium metal, VO, V₂O₃, V₂O₄, V₂O₅, a and NH₄VO₃.

The mixture may further include a metal-containing source material selected from the group consisting of Mg, Si, Sc, Cu, Zu, Nb, Y, and a combination thereof. The metal-containing source material may include the selected metal in a form selected from the group consisting of an oxide, a hydroxide, a carbonate salt, a sulfate, an oxalate, and a combination thereof.

The carbon material may be simultaneously mixed with a lithium source material, a vanadium source material, and the like, or after mixing other materials such as a lithium source material, a vanadium source material, and the like except for the carbon material, the carbon material may be mixed with the resulting mixture. In the mixing process, a metal-containing source material may be further added thereto. In the two-step mixing process, a metal-containing source material may be simultaneously mixed with a lithium source material and a vanadium source material.

The firing may be performed at a temperature ranging from about 700 to 1300° C., and in particular, from about 1000 to 1300° C. When the firing is performed through two steps, the first firing may be performed at a temperature ranging from about 700 to 1000° C., while the second firing may be performed at a temperature ranging from about 1000 to 1300° C. Further, when the firing is performed in two steps, a pulverization process may be further included after the first firing.

According to still another embodiment of the present invention, provided is a lithium secondary battery including a negative electrode including a negative active material including a compound and a carbon composite represented by Chemical Formula 1, a positive electrode including a positive active material, and a non-aqueous electrolyte.

According to one embodiment of the present invention, a lithium secondary negative active material may be prepared to have a high reductive property and to simultaneously secure safety by adding a carbon material and firing the resulting mixture, and also to have a uniform particle size distribution by suppressing abnormal particle growth. In addition, a carbon material may be increasingly added to control the particles. Furthermore, when a negative active material for a lithium secondary battery is prepared in two firing steps, particles may have higher uniformity by performing a pulverization process after the first firing, resultantly improving battery performance.

### DETAILED DESCRIPTION OF THE EMBODIMENTS

Exemplary embodiments of the present invention will hereinafter be described in detail. However, these embodiments are only exemplary, and the present invention is not limited thereto.

According to one embodiment of the present invention, provided is a negative active material including a compound and a carbon composite having a composition represented by the following Chemical Formula 1.

LiₐV_{b}M_{c}O_{2+d} [Chemical Formula 1]

In the above Chemical Formula 1, a, b, c, and d represent a composition ratio, 0.1≦a≦2.5, 0.5≦b≦1.5, 0≦c≦0.5, 0≦d≦0.5, and M is Mg, Si, Sc, Cu, Zu, Nb, Y, or a combination thereof.

The compound and the carbon composite having Chemical Formula 1 may include carbon in an amount ranging from about 0.01 to 4.0 wt %. In particular, the carbon may be included in an amount ranging from about 1.0 to 3.0 wt %. When the carbon is included within the range, it may increase conductivity of a negative active material and suppress non-reversibility.

The compound having Chemical Formula 1 may have a powder with a particle diameter ranging from 5 to 50 μm, or may have a more uniform particle size distribution ranging from about 10 to 30 μm. When it has a particle diameter within the range, it may prevent specific surface area dispersion o (workability) deterioration and simultaneously high rate characteristic deterioration. It can also absorb internal stress of its powder.

In addition, a negative active material for a lithium secondary battery of the present invention may have a lattice constant ratio (c/a) between a and c axes of about 5.1 to 5.2. When it has a lattice constant ratio within the range, it may maintain a stable crystal phase when intercalating/deintercalating lithium.

According to another embodiment of the present invention, provided is a method of preparing a negative active material for a lithium secondary battery, which includes firing the mixture of a lithium source material, a vanadium source material, and a carbon material.

The lithium source material may include at least one selected from the group consisting of Li₂O, LiCl, LiOH, and lithium carbonate (Li₂CO₃) or lithium acetate (CH₃COOLi). Among them, the lithium carbonate (Li₂CO₃) may have some advantages in terms of economy and the like.

The vanadium source material may be at least one selected from the group consisting of vanadium metal, VO, V₂O₃, V₂O₄, V₂O₅, and NH₄VO₃. Among them, the NH₄VO₃ may have some advantages in terms of economy, stability, and safety.

The compound having Chemical Formula 1 may further include the metal-containing source material. The metal-containing source material may include an oxide, a hydroxide, a carbonate salt, a sulfate, an oxalate, or the like including a metal selected from Mg, Si, Sc, Cu, Zu, Nb, Y, and a combination thereof. For example, when the metal is Mg, it may include MgO, Mg(OH)₂, MgCO₃, MgSO₄, MgC₂O₄, and the like.

The carbon material may include crystalline carbon, amorphous carbon, or a combination thereof. The carbon material may operate as a reducing agent during the firing, and may remain in an amount of about 0.01 to 4.0 wt % based on the entire weight of a final negative active material. The crystalline carbon may include amorphous, plate, flake, spherical, or fiber natural graphite or artificial graphite. Examples of the amorphous carbon may include soft carbon (low-temperature fired carbon), hard carbon, mesophase pitch carbide, fired coke, carbon black such as acetylene black, and the like. It may appropriately include carbon black among them.

The mixture may be prepared through a one-step process of simultaneously mixing a lithium source material, a vanadium source material, and selectively a metal-containing source material with a carbon material, or through a two-step process of mixing a lithium source material, a vanadium source material, and selectively a metal-containing source material, and then adding a carbon material thereto.

Regardless of whether a one- or two-step mixing process is used, the mixing may be performed in a common dry mixing method, for example, using a Henschel blender, a Pro Share blender, or the like.

In addition, regardless of whether the one- or two-step mixing process is used, a lithium source material, a vanadium material, and selectively a metal-containing source material are mixed in an appropriate ratio having a composition represented by Chemical Formula 1.

The carbon material may be added in an amount of about 0.1 to 10.0 wt %, and in particular, in an amount of about 0.1 to 7.0 wt % based on the entire amount of an active material considering the reductive property and the amount of remaining carbon. When it is included within the range, a negative active material may be prepared to have appropriate discharge capacity due to a small amount of impurities such as Li₃VO₄ and the like and an appropriate particle diameter size of a compound represented by Chemical Formula 1. In addition, when it is added within the range, it may appropriately bring about a reduction reaction of a starting material and thus suppress excessive production of impurities and form a final crystal structure. Accordingly, it can improve electrochemical characteristics of a negative active material having a form of a compound or a carbon composite represented by Chemical Formula 1.

The mixture may be fired using a gas furnace. Whether the gas furnace is permanent or disposable, it should circulate a particular gas during is the firing in order to avoid atmospheric influence. Directly before the firing, the atmosphere gas charged in the furnace may include an inert gas such as He (helium), Ar (argon), N₂ (nitrogen), and the like, or a gas prepared by mixing an inert gas such as He (helium), Ar (argon), N₂ (nitrogen), and the like with a reductive gas such as H₂ (hydrogen), CO (carbon monoxide), N₂/H₂, and the like. Accordingly, the inert gas and the reductive gas may be mixed in a ratio ranging from about 100:0 to 95:5. When they have a mixing ratio of 100:0, there is no reductive gas. When they are used within the range, there is an advantage in terms of economically performing the process and composing a stable crystal phase. In particular, since a reaction under an inert atmosphere may have an advantage in terms of storage and safety, N₂ gas that is not reductive but is inert may be appropriately used.

The firing may be performed at a temperature ranging from about 700 to 1300° C. It may be performed at a temperature ranging from about 1000 to 1300° C.

The firing may include one-step firing or two-step firing. Either of them may be applied to the present invention. The first firing may be performed at a temperature ranging from about 700 to 1300° C., and in particular, from about 1000 to 1300° C. The second firing may be performed at a temperature ranging from about 700 to 1300° C., and in particular from about 1000 to 1300° C. The second firing may further include a pulverization process after the first firing.

The first firing may bring about a desired product, but the two-step firing may bring about excellent particle uniformity. There is no evident reason why the second firing brings about improvement of particle characteristics. However, the second firing maintains uniformity of the powder particles, improving battery performance, while the particles are not highly uniform after the first firing as a result of observing the powder prepared under various conditions with an electron microscope.

When the firing is performed at an excessively high temperature, it may be easy to generate scattered Li as well a impurities. Accordingly, it may be difficult to acquire a desired crystal structure. On the other hand, when it is performed at an excessively low temperature, a desired product with an undesired crystal structure such as Li₃VO₄ and the like may be acquired.

Accordingly, the first firing or the second firing may be performed at a temperature ranging from about 700 to 1300° C., and in particular, from about 1100 to 1200° C. In addition, the firing temperature may be maintained/supported for about 2 to 5 hours. In the case of the two-step firing, the first firing may be performed at a temperature ranging from about 700 to 1000° C. considering particle diameter and particle uniformity, and removal of carbonate gas and the like that produces impurities and has an influence on particle growth.

The fired product is pulverized and dispensed to prepare a negative active material including a compound and a carbon composite represented by Chemical Formula 1 and having a desired size ranging from about 5 to 50 μm.

The following examples illustrate the present invention in more detail. These examples, however, should not in any sense be interpreted as limiting the scope of the present invention.

### Example 1

Preparation Method

A mixed powder was prepared by mixing ammonium metavanadate (NH₄VO₃, Stratcor, Inc.), lithium carbonate (Li₂CO₃, FMC Co.), magnesium carbonate (Aldrich Chemical Co.), and acetylene black (Denki Kagaku Kogyo Kabushiki Kaisha) as a carbon material in a Heschel blender. They are mixed in a mole ratio of 1.1:0.87:0.03 among Li:V:Mg. The carbon material may be included in an amount of 2.0 wt % based on the entire weight of a negative active material.

This mixed powder was fired at 800° C. under a nitrogen atmosphere for 3 hours as a maintaining and supporting time (first firing). The fired product was cooled to room temperature and pulverized in an automatic mortar, and then fired at 1200° C. under a nitrogen atmosphere for 2 hours as a maintaining/supporting time (second firing). The resulting product was pulverized and dispensed, preparing a negative active material.

Evaluation Method

The negative active material was prepared into a pulverulent body and evaluated regarding properties using the following devices. In addition, the pulverulent bodies of Example 1 and Comparative Example 1 were evaluated regarding properties. The results are provided in Table 1.

Herein, an X-ray diffraction device (X'Pert, PANalytical) PRO-MRD PW3040/60) was used under the following conditions to calculate a lattice constant of c and a axes: 45 kV, 40 mA (CuKα), an angle of 5 to 110°, a scanning speed of 0.104446°/S, and a step size of 0.0083556°.

Their particle diameter and particle size distribution were measured using a micro track MT-3000 (NIKKISO CO., LTD.). The particle diameter was evaluated by a 50% a verage particle diameter (d50). The diameter non-uniformity was evaluated by a ratio of a 90% particle diameter (d90) and a 10% particle diameter (d10). The d10 indicates a particle size at a 10% volume ratio of the cumulative size-distribution curve, the d50 indicates a particle size at a 50% volume ratio of the cumulative size-distribution curve, and the d90 indicates a particle size at a 90% volume ratio of the cumulative size-distribution curve.

A ratio of d90/d10 in the powder indicates a particle diameter distribution. A smaller ratio means that the distribution of a particle diameter size is more concentrated on a particular value, and accordingly, the particle diameter has a uniform average size.

Its specific surface area was measured due to BET using an automatic surface area measurement device, Multisorb 12 (Yuasa Ionic).

### Comparative Example 1

A negative active material was prepared according to the same method as Example 1 by preparing Li_{1.10}V_{0.89}Ti_{0.01}O₂, a lithium vanadium-based oxide, without adding a carbon compound.

Preparation Method

A mixed powder was prepared by mixing metavanadic acid ammonium (NH₄VO₃, Stratcor, Inc.), lithium carbonate (Li₂CO₃, FMC Co.), titanium dioxide (TiO₂, Tayca Corporation), acetylene black (Denkki Kagaku) as a carbon material in a Henschel blender. They were mixed in a mole ratio of 1.1:0.89:0.01 among Li:V:Mg, but did not include carbon.

This mixed powder was fired at 800° C. under a nitrogen atmosphere for 3 hours as a maintaining/supporting time (first firing). The fired product was cooled to room temperature, pulverized in an automatic mortar, and then fired at 1100° C. under a nitrogen atmosphere for 2 hours as a maintaining/supporting time (second firing). The resulting product was pulverized and dispensed, preparing a negative active material.

Electrochemical Evaluation of Negative Active Materials

80 wt % of the negative active material according to Example 1, 10 wt % of carbon black as a conductive material, and 10 wt % of polyvinylidene fluoride (PVDF) as a binder were dissolved in N-methyl pyrrolidone, preparing a slurry. The slurry was coated on a Cu film and then dried. The dried sheet was taken off with a punch to prepare an electrode for testing. On the other hand, metal lithium was used as a counter electrode. The counter electrode was prepared by perforating a Li metal foil.

Next, a separator made of polypropylene was positioned between the electrode for testing and the counter electrode to prepare an electrode assembly. The electrode assembly was placed in a coin-type battery container. Then, an electrolyte solution was prepared by mixing ethylene carbonate (EC) and dimethyl carbonate (DMC) in a ratio of 3:7 and dissolving 1.3M of LiPF₆ in the mixed solvent. The electrolyte solution was implanted in a battery container and the container was sealed, fabricating a coin-type cell for testing the negative active material according to Example 1.

Likewise, a coin-type cell for testing the negative active material according to Comparative Example 1 was fabricated according to the same method as aforementioned.

Each cell respectively including the negative active materials according to Example 1 and Comparative Example 1 was charged with a 0.2C constant current until it had a 0V charge ending voltage, and was then charged with a constant voltage for 3 hours. Then, it was discharged with a 0.2C discharge current until it had a voltage of 2.0V. Tables 1 and 2 show discharge capacity of each battery with fabrication conditions and powder properties.

TABLE 1

| | | Addition amount | First firing | | | Second firing | |
|---|---|---|---|---|---|---|---|
| | | of carbon | Temperature | Time | | Temperature | Time |
| | Composition | material wt %) | (° C.) | (h) | Pulverization | (° C.) | (h) |
| Ex. 1 | Li_{1.10}V_{0.87}Mg_{0.03}O₂ | 2.0 | 800 | 3 | performed | 1200 | 2 |
| Comp. | Li_{1.10}V_{0.89}Ti_{0.01}O₂ | 0.0 | 800 | 3 | — | 1100 | 2 |
| Ex. 1 | | | | | | | |

TABLE 2

| | Powder properties | | | | |
|---|---|---|---|---|---|
| | | Particle | | | Battery performance |
| | | diameter | d90/d10 | BET | discharge capacity |
| | c/a | (μm) | distribution | (m²/g) | (mAh/g) |
| Ex. 1 | 5.112 | 35.7 | 2.5 | 0.11 | 319 |
| Comp. | 5.142 | 16.5 | 10.0 | 0.21 | 265 |
| Ex. 1 | | | | | |

Referring to Table 2, the pulverulent body of Example 1 had better properties than the one of Comparative Example 1. The battery fabricated according to Example 1 turned out to have excellent performance compared with the one according to Comparative Example 1.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. The negative active material for a lithium secondary battery comprising a compound and a carbon composite having a composition represented by the following Chemical Formula 1:
LiₐV_{b}M_{c}O_{2+d} [Chemical Formula 1]
wherein, in the above Chemical Formula 1, a, b, c, and d represent a composition ratio, 0.1≦a≦2.5, 0.5≦b≦1.5, 0≦c≦0.5, 0≦d≦0.5, and M is Mg, Si, Sc, Cu, Zu, Nb, Y, or a combination thereof.

2. The negative active material of claim 1, which comprises the carbon in an amount of 0.01 to 4.0 wt % based on the entire amount thereof.

3. The negative active material of claim 1, which comprises the carbon in an amount of 1.0 to 3.0 wt % based on the entire amount thereof.

4. The negative active material of claim 1, wherein the compound represented by Chemical Formula 1 has a powder particle diameter ranging from 5 to 50 μm.

5. The negative active material of claim 1, which has a lattice constant ratio (c/a) between a and c axes of 5.1 to 5.2.

6. A method of preparing a negative active material for a lithium secondary battery comprising a compound represented by the following Chemical Formula 1, which comprises firing a mixture of a lithium source to material, a vanadium source material, and a carbon material, or a mixture of a lithium source material, a vanadium source material, a metal (M)-containing material, and a carbon material,
LiₐV_{b}M_{c}O_{2+d} [Chemical Formula 1]
wherein, in the above Chemical Formula 1, a, b, c, and d represent a composition ratio, 0.1≦a≦2.5, 0.5≦b≦1.5, 0≦c≦0.5, 0≦d≦0.5, and M is Mg, Si, Sc, Cu, Zu, Nb, Y, or a combination thereof.

7. The method of claim 6, wherein the lithium source material is at least one selected from the group consisting of Li₂O, LiCl, LiOH, Li₂CO₃, and CH₃COOLi.

8. The method of claim 6, wherein the vanadium source material is at least one selected from the group consisting of vanadium metal, VO, V₂O₃, V₂O₄, V₂O₅, and NH₄VO₃.

9. The method of claim 6, wherein the metal-containing source material comprises a metal selected from the group consisting of Mg, Si, Sc, Cu, Zu, Nb, Y, and a combination thereof in a form selected from the group consisting of an oxide, a hydroxide, a carbonate salt, a sulfate, an oxalate, and a combination thereof.

10. The method of claim 6, wherein the compound represented by Chemical Formula 1 is prepared through a first step of simultaneously mixing a lithium source material, a vanadium source material, and a carbon material.

11. The method of claim 10, wherein a metal-containing source material is further added in the mixing process.

12. The method of claim 6, wherein the compound represented by Chemical Formula 1 is prepared through two steps of mixing a lithium source material and a vanadium source material, and adding a carbon material to the mixture.

13. The method of claim 12, wherein a metal-containing source material is also added to the mixture when the lithium source material and the vanadium source material are added thereto.

14. The method of claim 6, wherein the firing is performed at a temperature ranging from 700 to 1300° C.

15. The method of claim 6, wherein the firing is performed at a is temperature ranging from 1000 to 1300° C.

16. The method of claim 6, wherein the first firing is performed at a temperature ranging from 700 to 1000° C., and the second firing is performed at a temperature ranging from 1000 to 1300° C.

17. The method of claim 15, which further comprises pulverization after the first firing.

18. A lithium secondary battery comprising:
a negative electrode comprising a negative active material;
a positive electrode comprising a positive active material; and
a non-aqueous electrolyte,
wherein the negative active material comprises a compound and a carbon composite represented by the following Chemical Formula 1:
LiₐV_{b}M_{c}O_{2+d} [Chemical Formula 1]
wherein, in the above Chemical Formula 1, a, b, c, and d represent a composition ratio, 0.1≦a≦2.5, 0.5≦b≦1.5, 0≦c≦0.5, 0≦d≦0.5, and M is Mg, Si, Sc, Cu, Zu, Nb, Y, or a combination thereof.

19. The lithium secondary battery of claim 18, wherein the carbon is comprised in an amount of 0.01 to 4.0 wt % based on the entire weight of the negative active material.

20. The lithium secondary battery of claim 18, wherein the compound represented by Chemical Formula 1 has a powder particle diameter ranging from 5 to 50 μm.

21. The lithium secondary battery of claim 18, wherein the negative active material for a lithium secondary battery has a lattice constant ratio (c/a) ranging from 5.1 to 5.2 between a and c axes.
